(19) United States
(12) Patent Application Publication
(10) Pub. No.: US 2026/0316092 A1
(43) Pub. Date: Oct. 15, 2026

(54) CYCLONE DEVICE FOR SURFACE FINISHING

(71) Applicant: EVERINN INTERNATIONAL CO., LTD., Taichung City (TW)

(72) Inventor: Tsung-Hsin WU, Taichung City (TW)

(21) Appl. No.: 19/285,785

(22) Filed: Jul. 30, 2025

(30) Foreign Application Priority Data
Feb. 10, 2025 (TW) 114104904

(51) Int. Cl. B04C 5/103; B01D 45/16

(52) U.S. Cl. CPC B04C 5/103; B01D 45/16

(57) ABSTRACT

A cyclone device for surface finishing is adapted for altering a surface of an object. The cyclone device includes a base unit, a motion unit, and a circulation unit. The motion unit is movable relative to the base unit in an extending direction of an axis. The circulation unit includes a tubular member that surrounds the axis, a press ring that is disposed on the tubular member and that surrounds the axis, and a carry seat that is adapted for carrying the object. The motion unit is operable to move relative to the base unit between an open position, in which the press ring and the carry seat are spaced apart from each other in the extending direction of the axis, and a closed position, in which the tubular member is adapted for accommodating the object, and in which the press ring presses against the carry seat.

### CROSS-REFERENCE TO RELATED APPLICATION

This application claims priority to Taiwanese Invention Patent Application No. 114104904, filed on Feb. 10, 2025, the entire disclosure of which is incorporated by reference herein.

### FIELD

The disclosure relates to a processing equipment, and more particularly to a cyclone device for surface finishing.

### BACKGROUND

Generally, a surface finishing process, such as anti-rust coating and polishing, is used to alter a surface of a workpiece for making the surface of the workpiece aesthetically pleasing, or for making the workpiece be able to be slidably and smoothly connected to other components. During the anti-rust coating process, a corrosion inhibitor is sprayed on the surface of the workpiece by a spray gun, and then the workpiece is rested for excess corrosion inhibitor to drip off the workpiece.

However, during the anti-rust coating process, it is difficult to prevent the corrosion inhibitor from getting on an unwanted place or an operator, and dust in the air may contaminate the corrosion inhibitor, which decreases the quality of a surface of a finished product. In addition, in order to make the workpiece well coated with the corrosion inhibitor, the amount of the corrosion inhibitor used in the anti-rust coating process may not be reduced, and the time needed for the excess corrosion inhibitor to drip off is time-consuming, so usage of the corrosion inhibitor is not convenient. There is still room for improvements in maintaining a clean environment and achieving user friendliness in the process.

### SUMMARY

Therefore, an object of the disclosure is to provide a cyclone device for surface finishing that can alleviate at least one of the drawbacks of the prior art.

According to the disclosure, the cyclone device for surface finishing is adapted for altering a surface of an object. The cyclone device includes a base unit, a motion unit, an actuation unit, and a circulation unit. The motion unit is movably disposed on the base unit, and is movable relative to the base unit in an extending direction of an axis. The actuation unit is disposed on the base unit, and is operable to urge the motion unit to move. The circulation unit includes two end caps that are respectively disposed on the base unit and the motion unit, a tubular member that is disposed on one of the base unit and the motion unit, and that surrounds the axis, a press ring that is disposed on the tubular member and that surrounds the axis, a carry seat that is disposed on another one of the base unit and the motion unit, and that is adapted for carrying the object, a plurality of duct members that are connected to the end caps, and a blower that is in spatial communication with the plurality of duct members. Each of the end caps has two openings that are in spatial communication with the plurality of duct members. The motion unit is operable to move relative to the base unit between an open position, in which the press ring and the carry seat are spaced apart from each other in the extending direction of the axis and in which a surface of the carry seat facing the press ring is exposed to an external environment, and a closed position, in which the tubular member is adapted for accommodating the object, in which the press ring presses against the carry seat, and in which the end caps, the tubular member, the carry seat, the plurality of duct members, and the blower cooperatively define a circulation pathway adapted for a fluid to flow through.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary perspective view of an embodiment of a cyclone device for surface finishing according to the disclosure.

FIG. 2 is a fragmentary front view illustrating a motion unit of the embodiment in an open position.

FIG. 3 is a fragmentary front view illustrating the motion unit in a closed position.

FIG. 4 is a fragmentary sectional view taken along line IV-IV of FIG. 3.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

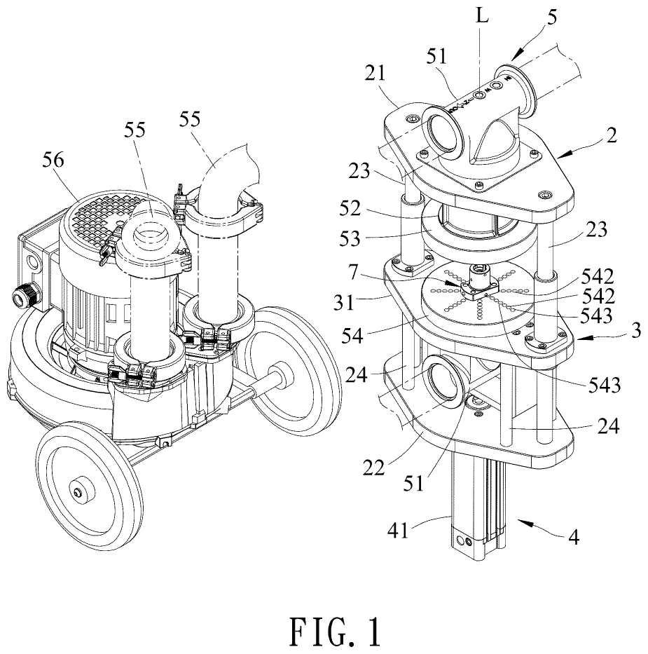

Referring to FIGS. 1 to 4, an embodiment of a cyclone device for surface finishing according to the disclosure is adapted for altering a surface of an object 7. The cyclone device includes a base unit 2, a motion unit 3, an actuation unit 4, a circulation unit 5, and a cyclone annular member 6.

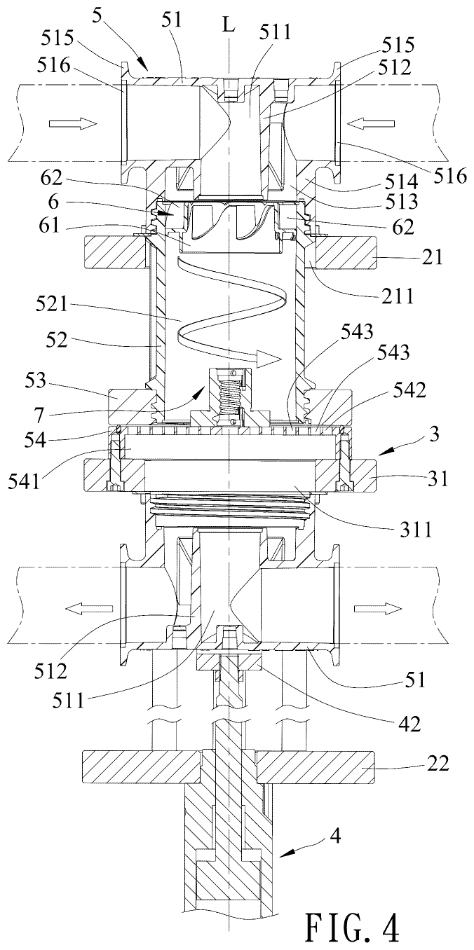

The base unit 2 includes a first base seat 21 and a second base seat 22 that are spaced apart from each other in an extending direction of an axis (L), and a plurality of guide rods 23 that extend in the extending direction of the axis (L) and that interconnect the first base seat 21 and the second base seat 22, and a plurality of limitation members 24 that are disposed on the second base seat 22. The first base seat 21 has an installation hole 211 (see FIG. 4) that extends therethrough in the extending direction of the axis (L). In this embodiment, the number of the guide rods 23 is two. In some embodiments, the number of the guide rods 23 may be, but not limited to be, three or more than three, according to actual requirements. In this embodiment, the guide rods 23 are located at two opposite sides of the axis (L) in a radial direction of the axis (L). The radial direction of the axis (L) is perpendicular to the extending direction of the axis (L). In some embodiments, an arrangement of the guide rods 23 may not be limited to the abovementioned arrangement, and the guide rods 23 may be arranged differently according to actual requirements.

The motion unit 3 is movably disposed on the base unit 2, and is movable relative to the base unit 2 in the extending direction of the axis (L). The motion unit 3 includes a slide seat 31 that is movable in the extending direction of the axis (L), and a plurality of sleeve tubes 32 that extend through the slide seat 31 and that are respectively sleeved on the guide rods 23. The slide seat 31 is located between the first base seat 21 and the second base seat 22. The limitation members 24 extend toward the slide seat 31 (i.e., the limitation members 24 extend toward the first base seat 21). The slide seat 31 has a vent hole 311 (see FIG. 4) that extends therethrough in the extending direction of the axis (L). The sleeve tubes 32 are respectively slidable relative to the guide rods 23 so that the slide seat 31 may smoothly move relative to the first base seat 21. A range of motion of the slide seat 31 is limited by the limitation members 24.

The actuation unit 4 is disposed on the second base seat 22, and is operable to urge the motion unit 3 to move. The actuation unit 4 includes an actuation member 41 that is disposed on and extends through the second base seat 22, and an interconnection member 42 that interconnects the actuation member 41 and the slide seat 31. The actuation member is operable to urge the interconnection member 42 to move so that the slide seat 31 is moved together with the interconnection member 42.

Referring to FIGS. 1, 2, and 4, the circulation unit 5 includes two end caps 51 that are respectively disposed on the first base seat 21 and the slide seat 31, a tubular member 52 that is disposed on the base unit 2 and that surrounds the axis (L), a press ring 53 that is disposed on a bottom end of the tubular member 52 and that surrounds the axis (L), a carry seat 54 that is disposed on the slide seat 31 and that is adapted for carrying the object 7, a plurality of duct members 55 that are connected to the end caps 51, and a blower 56 that is in spatial communication with the duct members 55. Each of the end caps 51 has a tubular body portion 512 that surrounds the axis (L) and that defines a body passage 511, and a main body portion 514 that surrounds the tubular body portion 512 and that cooperates with the tubular body portion 512 to define an annular passage 513. The main body portion 514 of each of the end caps 51 has two flanges 515 that are arranged oppositely and that respectively define two openings 516. The openings 516 of the main body portion 514 of each of the end caps 51 are in spatial communication with the duct members 55. The carry seat 54 has a ventilation space 541 that is formed in a bottom surface thereof, and a plurality of through hole groups 542 that are formed in a top surface thereof, that are spaced apart from each other, and that are arranged angularly about the axis (L). Each of the through hole groups 542 has a plurality of through holes 543 that are arranged in the radial direction of the axis (L), and that are spaced apart from each other. The ventilation space 541 is in spatial communication with the through holes 543 of the through holes groups 542, and the vent hole 311 of the slide seat 31. It is noted that, different types of fittings may be used with the cyclone device so as to regulate a flow direction of a fluid or to adjust joints. For example, in this embodiment, tee fittings may be used so that one of the duct members 55 that are connected to the blower 56 may be simultaneously connected to both of the openings 516 of the main body portion 514 of the end cap 51 that is disposed on the first base seat 21, while another one of the duct members 55 that are connected to the blower 56 may be simultaneously connected to both of the openings 516 of the main body portion 514 of the end cap 51 that is disposed on the slide seat 31. In some embodiments, those skilled in the art may use other components, according to actual requirements, to regulate the flow of the fluid. Those components may be, for example, valves or caps, and may not be limited thereto.

In this embodiment, the tubular member 52 is threadedly connected to the end cap 51 that is disposed on the first base seat 21, and the carry seat 54 is disposed on the slide seat 31. In some embodiments, the tubular member 52 may be threadedly connected to the end cap 51 that is disposed on the slide seat 31, while the carry seat 54 is disposed on the first base seat 21. Arrangements of the tubular member 52 and the carry seat 54 are not limited to the arrangements of the tubular member 52 and the carry seat 54 in this embodiment.

The cyclone annular member 6 is disposed in the tubular member 52, and has an annular main body 61 that surrounds the axis (L), and a plurality of vanes 62 that are formed on an external surface of the annular main body 61, and that are adapted for guiding the fluid so that a vortex is generated in the tubular member 52 by the fluid.

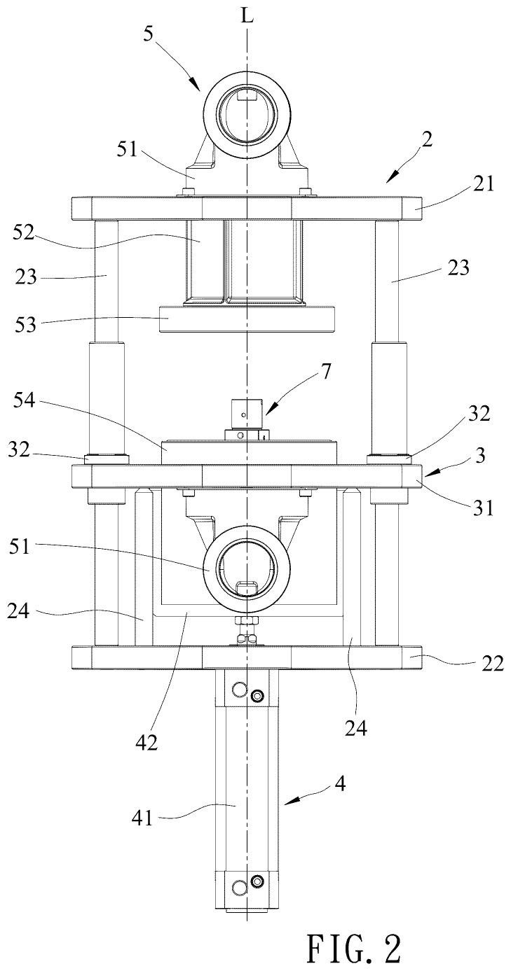

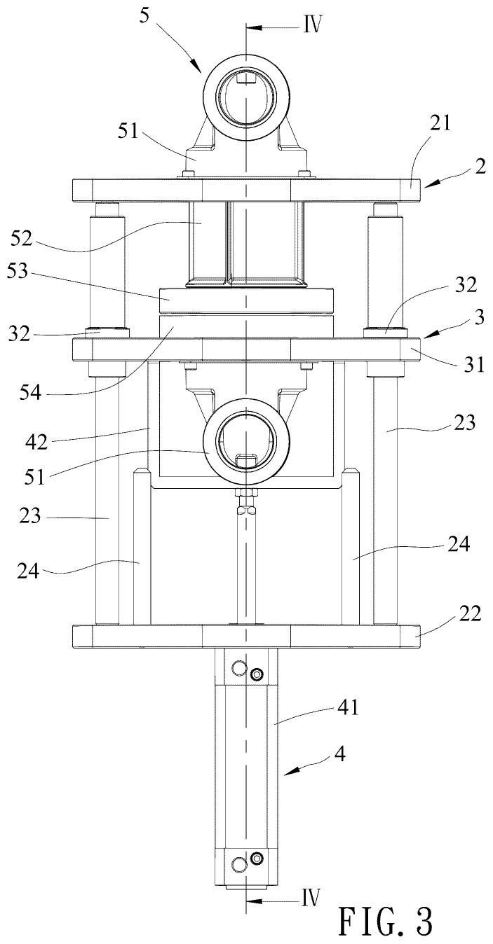

The motion unit 3 is operable to move relative to the base unit 2 between an open position (see FIG. 2) and a closed position (see FIGS. 3 and 4). When the motion unit 3 is in the open position, the press ring 53 and the carry seat 54 are spaced apart from each other in the extending direction of the axis (L), a surface of the carry seat 54 that faces the press ring 53 is exposed to an external environment, and the limitation members 24 abut against the slide seat 31. In this embodiment, a top surface of the carry seat 54 is exposed to the external environment. For some embodiments in which the tubular member 52 is disposed on the slide seat 31 while the carry seat 54 is disposed on the first base seat 21, a bottom surface of the carry seat 54 is exposed to the external environment when the motion unit 3 is in the open position. When the motion unit 3 is in the closed position, the tubular member 52 is adapted for accommodating the object 7, the press ring 53 presses against the carry seat 54, and the tubular member 52 and the carry seat 54 cooperatively surround and define a vortex chamber 521 (see FIG. 4). In addition, when the motion unit 3 is in the closed position, the end caps 51, the vortex chamber 521 defined by the tubular member 52 and the carry seat 54, the duct members 55, and the blower 56 cooperatively define a closed circulation pathway adapted for the fluid to flow through.

When the cyclone device is in operation, the motion unit 3 is moved to the open position, and the object 7 is placed on the carry seat 54. Then, the actuation unit 4 is operated to urge the motion unit 3 to move to the closed position, and the object 7 is accommodated in the tubular member 52. The blower 56 urges the fluid to flow into the vortex chamber 521 through one of the end caps 51. The fluid generates the vortex and circulates through the circulation pathway so as to alter the surface of the object 7 through a surface finishing process. After the surface finishing process, the blower 56 is operated to drain the fluid, and the actuation unit 4 is operated to urge the motion unit 3 to move to the open position so that the object 7 may be taken out of the cyclone device.

It is noted that, the cyclone device according to the disclosure may be used for different types of surface finishing processes. For example, when the cyclone device is used for an anti-rust coating process, a corrosion inhibitor is mixed in the fluid so that the corrosion inhibitor may circulate through the circulation pathway and be evenly sprayed onto the surface of the object 7. When the cyclone device is used for a polishing process, a polishing fluid is mixed in the fluid so that the polishing fluid may circulate through the circulation pathway and continuously polish the surface of the object 7. Composition of the fluid may be adjusted according to actual requirements for processing an object, and may not be limited to the description above.

The cyclone device may further be assembled with, for example, a plurality of cyclone separation filter modules disclosed in Taiwanese Patent No. I589344, or a plurality of convective heat exchange devices disclosed in Taiwanese Patent No. I577960, via a connection mechanism, so as to adjust a degree of cleanliness and a temperature of the fluid. Since the relevant features of this disclosure do not concern adjustments of the fluid, which are known in the art, further details of the same are omitted herein for the sake of brevity.

Advantages of the cyclone device according to the present disclosure over prior arts can be summarized as follows.
1. By virtue of the end caps 51, the tubular member 52, the carry seat 54, the duct members 55, and the blower 56 cooperatively define the closed circulation pathway, the fluid is not exposed to the external environment and does not make the external environment dirty, thereby achieving an effect of maintaining a clean environment.
2. By virtue of the fluid circulating through the circulation pathway, negative effects caused by the air in the external environment upon the fluid are reduced, which reduces speed of deterioration of the fluid and allows the fluid to be reusable. Thus, the amount of the fluid used in the surface finishing process is reduced and consumable costs are reduced, thereby achieving user friendliness.
3. Because the fluid circulates through the circulation pathway, the fluid may avoid contamination caused by dust and dirt in the air, thereby increasing quality of the surface of the object 7 after the surface finishing process.
4. The blower 56 is operable to drain the fluid after the surface finishing process, which eliminates a procedure of dripping the excess fluid off the object 7 and waiting for the object 7 to dry, thereby saving time.

Therefore, the purpose of the present disclosure is indeed achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A cyclone device for surface finishing, adapted for altering a surface of an object, the cyclone device comprising:
a base unit;
a motion unit movably disposed on the base unit, and movable relative to the base unit in an extending direction of an axis;
an actuation unit disposed on the base unit, and operable to urge the motion unit to move; and
a circulation unit including two end caps that are respectively disposed on the base unit and the motion unit, a tubular member that is disposed on one of the base unit and the motion unit, and that surrounds the axis, a press ring that is disposed on the tubular member and that surrounds the axis, a carry seat that is disposed on another one of the base unit and the motion unit, and that is adapted for carrying the object, a plurality of duct members that are connected to the end caps, and a blower that is in spatial communication with the plurality of duct members, each of the end caps having two openings that are in spatial communication with the plurality of duct members, the motion unit being operable to move relative to the base unit between an open position, in which the press ring and the carry seat are spaced apart from each other in the extending direction of the axis and in which a surface of the carry seat facing the press ring is exposed to an external environment, and a closed position, in which the tubular member is adapted for accommodating the object, in which the press ring presses against the carry seat, and in which the end caps, the tubular member, the carry seat, the plurality of duct members, and the blower cooperatively define a circulation pathway adapted for a fluid to flow through.

2. The cyclone device for surface finishing as claimed in claim 1, wherein the base unit includes a first base seat and a second base seat that are spaced apart from each other in the extending direction of the axis, one of the end caps being disposed on the first base seat.

3. The cyclone device for surface finishing as claimed in claim 2, wherein the base unit further includes a plurality of guide rods that extend in the extending direction of the axis and that interconnect the first base seat and the second base seat, the motion unit including a slide seat and a plurality of sleeve tubes, another one of the end caps being disposed on the slide seat, the plurality of sleeve tubes extending through the slide seat and being respectively sleeved on the plurality of the guide rods.

4. The cyclone device for surface finishing as claimed in claim 3, wherein the base unit further includes a plurality of limitation members that are disposed on one of the first base seat and the second base seat and that extend toward another one of the first base seat and the second base seat, the plurality of limitation members abutting against the slide seat when the motion unit is in the open position.

5. The cyclone device for surface finishing as claimed in claim 3, wherein the slide seat is located between the first base seat and the second base seat, the actuation unit including an actuation member that is disposed on the second base seat, and an interconnection member that interconnects the actuation member and the slide seat, the actuation member being operable to urge the interconnection member to move so that the slide seat is moved together with the interconnection member.

6. The cyclone device for surface finishing as claimed in claim 1, wherein each of the end caps has a tubular body portion that surrounds the axis and that defines a body passage, and a main body portion that surrounds the tubular body portion and that cooperates with the tubular body portion to define an annular passage.

7. The cyclone device for surface finishing as claimed in claim 1, wherein the carry seat has a ventilation space that is formed in a bottom surface thereof, and a plurality of through hole groups that are formed in a top surface thereof, that are spaced apart from each other, and that are arranged angularly about the axis, each of the plurality of through hole groups having a plurality of through holes that are arranged in a radial direction of the axis, that are spaced apart from each other, and that are in spatial communication with the ventilation space, the radial direction of the axis being perpendicular to the extending direction of the axis.

8. The cyclone device for surface finishing as claimed in claim 1, further comprising a cyclone annular member that is disposed in the tubular member, the cyclone annular member having an annular main body that surrounds the axis, and a plurality of vanes that are formed on an external surface of the annular main body, and that are adapted for guiding the fluid so that a vortex is generated in the tubular member by the fluid.
